(19) United States
(12) Patent Application Publication
(10) Pub. No.: US 2018/0016139 A1
(43) Pub. Date: Jan. 18, 2018

(54) HYDROGEN STORAGE IN NANOPOROUS AND NANOSTRUCTURED HYDRIDE FORMING METALS

(71) Applicant: THE REGENTS OF THE UNIVERSITY OF CALIFORNIA, Oakland, CA (US)

(72) Inventors: Sarah Tolbert, Los Angeles, CA (US); Eric Detsi, Los Angeles, CA (US)

(73) Assignee: THE REGENTS OF THE UNIVERSITY OF CALIFORNIA, Oakland, CA (US)

(21) Appl. No.: 15/649,163

(22) Filed: Jul. 13, 2017

Related U.S. Application Data
(60) Provisional application No. 62/361,600, filed on Jul. 13, 2016.

(51) Int. Cl. C01B 3/00; C01B 6/24; C01F 5/00

(52) U.S. Cl. CPC C01B 3/0031; C01B 6/24; C01F 5/00

(57) ABSTRACT

A solid state hydrogen storage system and materials are provided. Hydrogen storage is provided by the formation of metal hydrides in a nanoporous metal framework. H₂ can be effectively released from the hydride that is made directly during the synthesis processes at just 100° C. Dealloying using galvanic corrosion in a metal ion electrolyte and in a hydrogen containing atmosphere is used to create monolithic nanoporous metal frameworks and the simultaneous formation of metal hydrides within the porosity. The nanoporous frameworks have a tunable plasmon resonance and morphology. The system can reversibly store hydrogen in the nanoporous framework using hot electrons generated either by surface plasmons or by exothermic galvanic replacement reactions to form metal hydrides.

### CROSS-REFERENCE TO RELATED APPLICATIONS

This application claims priority to, and the benefit of, U.S. provisional patent application Ser. No. 62/361,600 filed on Jul. 13, 2016, incorporated herein by reference in its entirety.

### STATEMENT REGARDING FEDERALLY SPONSORED RESEARCH OR DEVELOPMENT

This invention was made with Government support under DE-SC0001342, awarded by the United States Department of Energy. The Government has certain rights in the invention.

### INCORPORATION-BY-REFERENCE OF COMPUTER PROGRAM APPENDIX

Not Applicable

### BACKGROUND

### 1. Technical Field

The technology of this disclosure pertains generally to synthesis methods for nanoporous materials, and more particularly to methods for fabricating solid-state, high-capacity reversible hydrogen gas storage systems.

### 2. Background Discussion

Hydrogen is a very attractive energy carrier for mobile applications because it can release energy with zero-emissions upon reaction with oxygen and it exhibits the highest gravimetric energy density (142 MJ/kg versus 47 MJ/kg for petroleum) of all of the common energy storage media. Hydrogen is also the most abundant element on earth. Nevertheless, hydrogen is not widely used as energy carrier. This is because hydrogen is a gas at room temperature and takes up a lot of space. In fact, hydrogen exhibits the lowest volumetric energy density of all common energy carriers (8.4 MJ/L versus 34 MJ/L for petroleum).

The large-scale usage of hydrogen as a clean and sustainable energy carrier has been delayed by the absence of high-capacity hydrogen storage systems that are compact, safe and cost-effective. Effective storage of hydrogen remains a big challenge and a common approach to store hydrogen for onboard applications is by mechanical compression in hydrogen tanks. Due to safety considerations associated with high-pressure flammable gases, it is anticipated that the storage capacity of compressed hydrogen tanks cannot be notably improved.

One promising alternative to gaseous-state hydrogen storage in compressed tanks is solid-state hydrogen storage in lightweight materials that are capable of releasing hydrogen atoms in a fuel cell at near room temperature and at atmospheric pressures. With a gravimetric and volumetric hydrogen storage capacity of 10.1 wt % and 149 kg H₂/m³ respectively, metal hydrides such as aluminum hydride (AlH₃) are very attractive candidate materials for solid-state reversible hydrogen storage.

Unfortunately, the direct storage of molecular hydrogen gas in aluminum requires very high hydrogen pressures. For example, the direct hydrogenation of aluminum to alane requires hydrogen pressures of over 10⁵ at room temperature. These high hydriding pressures have precluded alane from being considered as a reversible hydrogen storage material.

The high gas pressure requirements are not practical and alternative chemical and electrochemical synthesis routes for the production of materials such as aluminum hydride are necessary. Among chemical synthesis routes, the most popular one for aluminum hydride is the reaction of lithium aluminum hydride (LiAlH₄) with aluminum trichloride (AlCl₃) in diethyl ether, as given by the equation:

$${LiAlH}_{4} + {AlCl}_{3} {}^{Ether} {AlH}_{3} \cdot {Et}_{2} O + LiCl .$$

This reaction produces etherated compounds of aluminum hydride (AlH₃·Et₂O) and lithium chloride (LiCl). This synthesis route is very costly for reversible hydrogen storage in the form of AlH₃ because the regeneration of LiAlH₄ requires at least 117 kJ mol⁻¹. More importantly, the recovery of lithium metal from LiCl requires at least 429 kJ mol⁻¹ of energy as well as a high-temperature (600° C.) pre-treatment step with KCl. In addition to these high-recovery costs, pure AlH₃ is extracted from the synthesized AlH₃·Et₂O compound by heat-treatment in vacuum.

These synthesis methods are not practical, however, because they involve expensive and reactive chemicals (LiAlH₄, AlCl₃) and many energy intensive high temperature processing steps. Clearly, more cost effective and reversible methods of producing metal hydrides like AlH₃ for large-scale reversible storage of hydrogen applications are desirable.

Accordingly, there is a need for methods of fabrication of high-capacity, reversible, solid-state hydrogen storage systems that are reliable and inexpensive to produce.

### BRIEF SUMMARY

The present technology provides a high capacity hydrogen storage system and method for synthesis of solid-state reversible hydrogen storage materials that are compact, safe and cost effective. The solid-state storage system is an alternative to gaseous hydrogen storage. The system uses nanoporous, preferably non-precious metal structures for reversible gas storage that are capable of releasing hydrogen in a fuel cell near room temperature and atmospheric pressure, for example. The system and materials provide for cost-effective, repetitive hydrogen gas storage with the use of ultrafine nanoporous non-precious and non-noble metal frameworks and the formation of nanoporous metal hydrides.

With a gravimetric and volumetric hydrogen storage capacity of 10.1 wt % and 149 kg H₂/m³, aluminum hydride (AlH₃) is described to illustrate one material for solid-state reversible hydrogen storage. The hydrogen storage is provided by the formation of metal hydrides such as aluminum hydride in the nanoporous aluminum metal framework (NP—AlH₃). The NP—AlH₃ can be made directly during the synthesis processes and the H₂ can be effectively released with heating to just 100° C.

The system provides an innovative dealloying approach using galvanic corrosion to create monolithic nanoporous metals and the formation of metal hydrides within the porosity. The system also provides effective approaches to reversibly store hydrogen in the nanoporous framework using hot electrons generated either by surface plasmons or by exothermic galvanic replacement reactions.

Galvanic corrosion, also known as dissimilar metal corrosion or contact corrosion, is a natural corrosion process that takes place when two dissimilar metals are exposed to a corrosive electrolyte. Ultrafine nanoporous Al, for example, cannot be synthesized from existing dealloying methods. In standard dealloying methods with aqueous electrolytes, the alloy corrosion is caused by hydroxide or hydronium ions. However, some metals dissolve in both acidic and basic electrolyte solutions. Accordingly, the dealloying by dissimilar metal corrosion of the system is caused by metal cations, rather than hydroxide or hydronium ions. Consequently, undesirable aqueous electrolytes can be avoided during galvanic corrosion of non-precious metals.

Furthermore, engineered dissimilar metal structures do not normally give rise to monolithic nanoporous architectures after galvanic attack because the underlying metallic components usually exhibit macroscopic scale interfaces. Instead, a homogeneous atomic scale mixture of the two metallic components of a bimetal, like in binary alloys, is necessary in order to end up with a nanoporous architecture after galvanic corrosion.

The formation of metal hydride in the porosity of the nanoscale porous framework occurs in a hydrogen atmosphere. The excess energy ΔE from the exothermic galvanic reaction dissipates non-adiabatically at the surfaces of the nanopores by exciting hot electrons in the metal. The hot electrons that are produced separate the hydrogen gas into individual atoms that form metal hydride on the surface.

Similarly, aluminum also shows strong plasmonic absorption of visible light and the resulting energy can be used to covert NP—Al to NP—AlH₃ using visible light in the presence of H₂ gas to produce NP—AlH₃ from NP—Al at room temperature and 1 atm. pressure. The hydrogen can then be released by mild heating to 100° C., regenerating the NP—Al for further reaction, for example. In addition to visible light, the morphology of the metal frameworks can be tuned for plasmonic excitation by IR light, near IR light, UV light, and broader combinations of light. Photoinduced solid-state hydrogen storage is a fundamentally new concept that could significantly impact the mobile energy storage landscape.

Further aspects of the technology described herein will be brought out in the following portions of the specification, wherein the detailed description is for the purpose of fully disclosing preferred embodiments of the technology without placing limitations thereon.

### BRIEF DESCRIPTION OF THE SEVERAL VIEWS OF THE DRAWINGS

The technology described herein will be more fully understood by reference to the following drawings which are for illustrative purposes only:

FIG. 1 is a functional block diagram a method for fabricating solid state reversible hydrogen storage materials with nanoporous metal frameworks and metal hydride according to one embodiment of the technology.

FIG. 2 is a functional block diagram of off-board reversible hydrogen storage in nanoporous aluminum (NP—Al) according to the steps of FIG. 1.

FIG. 3 is a functional block diagram of light driven on-board reversible hydrogen storage in plasmonic nanoporous aluminum (NP—Al) using sunlight according to one embodiment of the technology.

FIG. 4 is a graph of H₂ desorption of NP—Al material at approximately 100° C.

FIG. 5 depicts graphs of in situ H₂ storage and ex-situ storage of H₂ using simulated sunlight.

### DETAILED DESCRIPTION

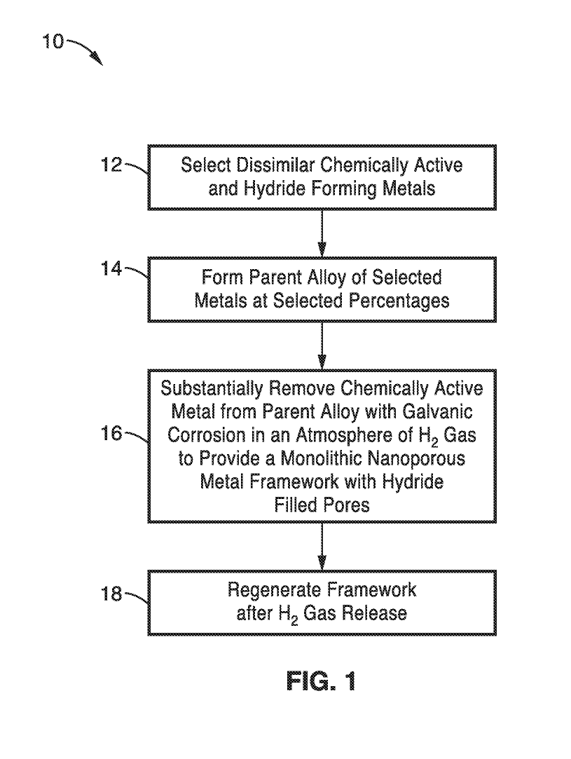

Referring more specifically to the drawings, for illustrative purposes, embodiments of methods for hot-electron induced hydrogen storage in nanoporous metal frameworks with the formation of metal hydrides during dealloying by galvanic corrosion are generally shown. Several embodiments of the technology are described generally in FIG. 1 to FIG. 5 to illustrate the characteristics and functionality of the materials and system. It will be appreciated that the methods may vary as to the specific steps and sequence and the systems and apparatus may vary as to structural details without departing from the basic concepts as disclosed herein. The method steps are merely exemplary of the order that these steps may occur. The steps may occur in any order that is desired, such that it still performs the goals of the claimed technology.

Generally, the technology is an innovative approach to the storage of hydrogen gas in nanoscale metal structures at ambient temperature and pressure. The methods exploit exothermic galvanic corrosion reactions to synthesize ultrafine nanoporous metal frameworks using dealloying in a hydrogen atmosphere. During that process, the excess energy from the exothermic reactions dissipates non-adiabatically at the nanoporous metal surfaces by exciting hot electrons in the metal. These hot electrons are transferred into hydrogen molecules physically adsorbed at the freshly formed nanoporous metal surface and induce their dissociation and chemisorption, resulting in the formation of nanoporous metal hydride in-situ during dealloying by galvanic corrosion.

The fabrication of a nanoporous aluminum framework material and aluminum hydride is used to illustrate the technology. Although the methods are demonstrated with aluminum alloys, the storage system and methods can be adapted and applied to other alloyed materials capable of forming hydrides.

Turning now to FIG. 1, a flow diagram of one embodiment of a method 10 for the fabrication of nanoporous metal frameworks with the formation of at least one type of metal hydride as a solid state reversible hydrogen storage material is shown schematically. At block 12 of FIG. 1, the metal hydride and metal hydride forming metals for the system are selected. The dissimilar metal for use in forming the parent alloy with the selected metal hydride forming metal is also selected in the step at block 12. As used herein, the term “metal hydride” refers to a hydride formed with any suitable metal with the process and is not limited to any particular group of metals. Non-precious metals are preferred. Possible metals include Al, Pd, Li, Na, Mg, Ti, Zr, Hf, V, Zn and any other metal that can form a hydride. In addition, the metals may includes metal alloys such as Mg₂FeH₆ or Mg₂NiH₄ and the large family of materials with the form AₓMHₙ, where A⁺ is an alkali or alkaline earth metal cation, e.g. K⁺ and Mg²⁺ and M is a metal.

The morphology of the final nanoporous hydrogen storage material produced by the methods may also be selected and tuned. Nanoporous metal frameworks are a three dimensional continuous network of randomly interconnected channels called pores and walls or struts commonly called ligaments. The preferred materials typically have wall thicknesses from 5 nm to 200 nm and pore sizes of 50 nm or less. The average pore size and ligament size of the materials can be determined by the percentages of metals that are selected parent alloy and the processing conditions.

At block 14, a parent alloy is formed from the selected hydride forming and dissimilar metals. The percentages of each of the metals in the parent alloy are also selected to control morphology and to optimize dealloying. Metal Architectures may include interconnected nanoporous metal sheets, metal nanocrystals, metal nanorods, and rough aggregates of nanoscale metal, for example.

Metal alloys are typically formed at block 14 by heating and melting the selected quantities of metals to form a homogeneous mixture. The range of temperatures required to melt the metals and form an alloy is determined by characteristics of the selected metals and can be optimized to reduce contamination and increase homogeneity. The resulting molten alloy can also be formed into shapes.

The alloy produced a block 14 is then dealloyed at block 16 of FIG. 1. However, conventional de-alloying methods will not work with the non-precious metal alloys used here. Conventional dealloying is a top-down synthesis technique where the most chemically active element is selectively removed from a dense precursor alloy, using acidic or alkaline aqueous electrolytes, eventually in combination with a bias voltage. The current dealloying method in aqueous electrolytes is not appropriate for the fabrication of nanoporous metals made of very reactive non-precious elements, which have their electrode potentials far below the standard hydrogen electrode like Mg, Al, Ti, Mn, Nb, Zn etc. The reason for this is because a non-precious metal will spontaneously react in an aqueous electrolyte and fully dissolve or cause the passivation of its parent alloy.

Therefore, an alternative dealloying route for the production of monolithic nanoporous metals including chemically more reactive metals is used. The method exploits the galvanic corrosion phenomenon, also known as dissimilar metal corrosion or contact corrosion, which is a natural corrosion process taking place when two dissimilar metals are exposed to a corrosive electrolyte. In the standard dealloying method in aqueous electrolyte, alloy corrosion is caused by hydroxide (OH⁻) ions or hydronium (H₃O⁺) ions. Since these ionic species attack less noble metals, they cannot be involved in the synthesis of non-precious nanoporous metals.

One feature of the dissimilar metal dealloying approach is that alloy corrosion is caused by metal cations rather than hydroxide OH⁻ or hydronium H₃O⁺ ions. Consequently, undesirable aqueous electrolytes can be avoided during galvanic corrosion of non-precious metals. Nevertheless, engineered dissimilar metal structures do not automatically give rise to monolithic nanoporous architecture after galvanic attack, because the underlying metallic components usually exhibit macroscopic scale interfaces. Instead, a homogeneous atomic scale mixture of the two metallic components of a bimetal, like in binary alloys, is needed in order to end up with a nanoporous architecture after galvanic corrosion.

The electrolyte that is selected for galvanic corrosion of the alloy at block 16 will depend on the identity of the chemically active and hydride forming metals that form the parent alloy. The electrolyte that is used will normally be an organic solvent electrolyte containing a metal cation of the hydride forming metal of the alloy. For example, galvanic corrosion is used to selectively extract magnesium (Mg) from an Aluminum/Magnesium (Al/Mg) bimetal parent alloy of the composition Al₃₀Mg₇₀ at.% to illustrate the methods. In this illustration, Al³⁺ is used to selectively oxidize the Mg metal phase from the Al/Mg parent alloy.

The driving force for the galvanic corrosion process is the difference in standard electrode potentials between the hydride forming metal ion/hydride forming metal pair and the chemically active metal ion/chemically active metal pair.

The dealloying process at block 16 takes place in an atmosphere of hydrogen gas. The hydrogen atmosphere uptake pressure (P_{H2}) is preferably in the range of from approximately 0.05 atm to approximately 10 atm. The preferred hydrogen uptake temperature is the range from approximately −40° C. to approximately 100° C.

During the dealloying process, the excess energy from the exothermic reactions dissipates non-adiabatically at the nanoporous metal surface by exciting hot electrons in the metal structure. These hot electrons are transferred to hydrogen gas molecules that are physically adsorbed on the freshly formed nanoporous metal surfaces and induce their dissociation and chemisorption, resulting in the formation of nanoporous metal hydride in-situ during the dealloying by galvanic corrosion process.

The hydrogen contained in the metal hydride within the porosity of the ultrafine nanoporous metal can be released by heating. The preferred release temperatures range from room temperature to approximately 200° C., depending on the type of metal hydride that is produced. Release of the hydrogen gas from the metal hydride leaves the nanoporous metal framework with open surfaces.

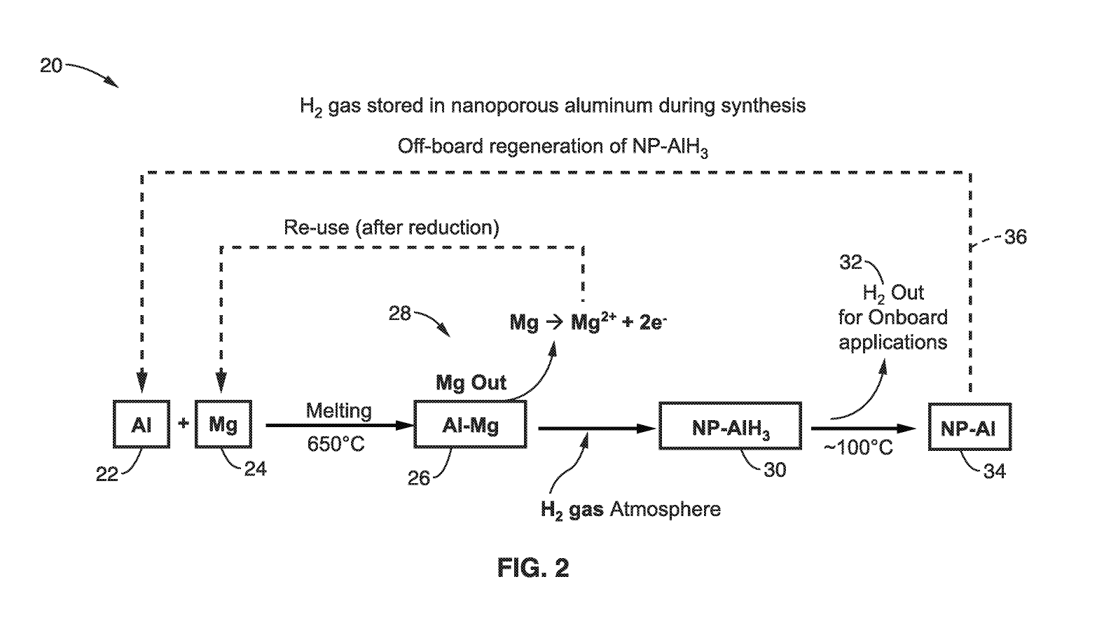

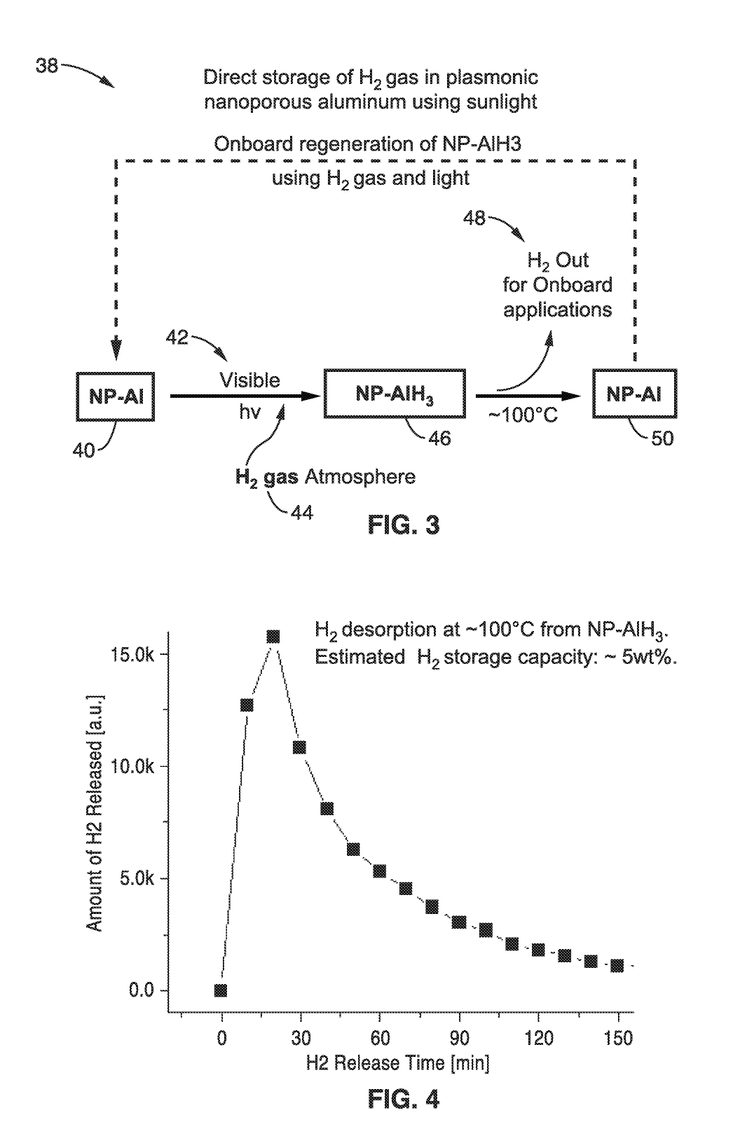

The open nanoporous metal framework can be regenerated at block 18 of FIG. 1. Hydrogen can be reversibly stored in the nanoporous framework using hot electrons generated either by surface plasmons or by exothermic galvanic replacement reactions to produce metal hydrides as shown in FIG. 2 and FIG. 3.

As with the initial hydride formation with the galvanic process, regeneration requires that molecular hydrogen be dissociated onto the metal surfaces of the pores prior to chemisorption of hydrogen atoms to form a metal hydride. For regeneration at block 18, hot electrons are generated from plasmonic excitations of the nanoporous metal framework dissociate and store molecular hydrogen in the form of ultrafine nanoporous metal hydride.

The plasmonic response of the nanoporous metal storage material is dependent on the identity of the metal and the particle morphology. For example, plasmonic gold and silver nanostructures are only active in the visible light spectrum. Whereas, nanoparticles of aluminum have been reported to exhibit a plasmonic response that is tunable from UV to Near-IR wavelengths, depending on the size and shape of the nanoparticles. Effective sunlight harvesting using plasmonic nanostructures will require materials that are susceptible to absorb sunlight ranging from UV to Near-IR wavelengths. Polydisperse Al nanoparticles with irregular shapes and random shaped nanostructures (ligaments and pores) exhibit a broad plasmonic response ranging from UV to Near-IR wavelengths. On the other hand, monodisperse Al nanoparticles with a given uniform shape exhibit a narrow plasmonic peak (either in the UV, Visible or Near-IR regime), meaning that these nanoparticles only absorb a relatively narrow fraction of the solar spectrum and may be suitable for laser excitation.

Due to the poor adsorption of H₂ molecules onto some metal surfaces, plasmonic nanoparticles may be coated with plasmonically passive oxide layers such as TiO₂ or SiO₂, into which hydrogen molecules diffuse in one embodiment. In that way, molecular hydrogen may stay longer near the metal nanoparticle surface to receive hot electrons transferred from these nanoparticles.

In an alternative embodiment shown schematically in FIG. 2, the nanoporous metal frameworks are dissembled and the metals recycled to form a new parent alloy and new nanoporous metal framework with metal hydride storage rather than regenerated.

The technology described herein may be better understood with reference to the accompanying examples, which are intended for purposes of illustration only and should not be construed as in any sense limiting the scope of the technology described herein as defined in the claims appended hereto.

### EXAMPLE 1

In order to demonstrate the fabrication methods and functionality of the solid-state hydrogen storage materials, a system 20 using an alloy of aluminum and magnesium metals was produced and tested. In the illustration shown in FIG. 2, an Al/Mg parent alloy 26 with eutectic composition (Al₃₀Mg₇₀ at.%) was made by homogeneously melting pure Al metal 22 and pure Mg metal 24 at 650° C. or at 750° C. in a graphite crucible, using a quartz tube under argon flow.

Two microstructural phases were observed in the eutectic Al/Mg alloys 26. A light phase, corresponding to an a-Mg solid solution, and a dark phase representing β-Al₁₂Mg₁₇intermetallics were evaluated. These two different phases are responsible for the bimodal porosity in nanoporous Al after selective removal of Mg to produce ultrafine nanoporous aluminum (NP—Al).

In this system, a metal cation Al³⁺ electrolyte was used to selectively oxidize the Mg metal phase 28 from the Al/Mg system. This avoided the use of an aqueous electrolyte containing H⁺ or OH⁻, since these ionic species are fatal for Al. Rather, an organic solvent electrolyte containing Al³⁺ was used to selectively corrode the Mg metal phase from the Al/Mg alloy 26 system. The magnesium metal could be recovered for re-use as a component of a parent alloy with aluminum.

The driving force in this galvanic corrosion setting in is the difference in standard electrode potentials between Al³⁺/Al pair (−1.66V vs. SHE) and the Mg²⁺/Mg pair (−2.37V vs. SHE). The corresponding overall reaction was: 3 Mg(s)+2Al³⁺→2Al(s)+3 Mg²⁺+ΔE. This reaction generates a potential difference of +0.71V, indicating that Al³⁺ ions should spontaneously oxidize Mg metal from the Al/Mg alloy without the need of external bias voltage. Accordingly, during corrosion of the Mg phase (acting as anode) in the Al/Mg alloy 26 by Al³⁺ from the electrolyte, the corresponding electronic charges from Mg oxidation reduce these Al³⁺ to Al atoms.

However, due to the atomic scale mixture of Al and Mg the deposition of reduced Al atoms from the electrolyte onto a pure solid Al phase was not favorable. Initially, the reduced Al atoms were seen to cluster to form Al nanoparticles as solid dealloying by-products, resulting in a dark suspension in the organic solvent electrolyte. As Mg atoms from the Al/Mg parent alloy gradually dissolve into the electrolyte, Al atoms that were left at the parent alloy/electrolyte interface reorganized to form Al clusters, which further grew into a 3D bicontinous porous network. The main dealloying product that was remaining after the Mg was fully extracted from the Al/Mg parent alloy 26 was a monolithic piece of mesoporous Al (NP—Al).

Energy dispersive x-ray spectroscopies (EDS) of the parent alloy before and after dealloying showed that the dominant Mg peak in the Al/Mg precursor before dealloying almost entirely vanished after dealloying. The content of residual Mg in dealloyed structures was less than 5 at.%.

The oxygen peaks before and after dealloying come from samples exposure during material characterizations. The carbon peaks before and after dealloying are attributed to carbon contamination from the graphite crucible. That contamination can be minimized by melting the Al/Mg parent alloy at lower temperatures (around 500° C.); however lowering the melting temperature significantly reduces the homogeneity of the Al/Mg precursor.

Scanning and transmission electron micrographs of dealloyed structures revealed large macropores and macropore walls (size ˜1-5 μm) at low magnifications. The large macropores came from the full dissolution of the a-Mg solid solution phase from the Al/Mg parent alloy. At higher magnifications, the macropore walls displayed an ultrafine porosity. The average pore and ligament size in these ultrafine structures was approximately 10 nm. These nanoscale pores come from the selective dissolution of Mg from the P—Al₁₂Mg₁₇phase.

The X-ray diffraction (XRD) patterns of the Al/Mg parent alloy before and after dealloying indicated that the ultrafine nanoporous Al preserved the face-centered cubic crystal structure of Al. The BET specific surface area was measured by nitrogen adsorption and found to be approximately ˜220 m²/g. This is more than one order of magnitude higher than specific surface areas reported in existing nanoporous metals.

Knowing that the specific surface area in disordered nanoporous metals with comparable ligaments and pores size is inversely proportional to the product pd, where p and d represent the bulk density and average ligaments size, respectively, the high specific surface area in mesoporous Al could be justified by the small ligaments size (d ˜10 nm) and the relatively low density of Al (p=2.7 g/cm³) compared to precious metals.

The dealloying of parent alloy 26 was conducted in a hydrogen gas atmosphere resulting in the formation of nanoporous aluminum hydride (NP—AlH₃) 30 on the surfaces of the ultrafine nanoporous aluminum (NP—Al) framework. Hydrogen gas 32 was effectively released from NP—AlH₃30 that was made directly during the synthesis processes by heating the material to approximately 100° C. as shown in FIG. 4. Conversion of the hydride and release of the hydrogen gas 32 produced an open NP—Al framework 34. The aluminum from this framework can be recycled 36 along with the magnesium to produce starting materials for the formation of new material in the embodiment shown in FIG. 2.

### EXAMPLE 2

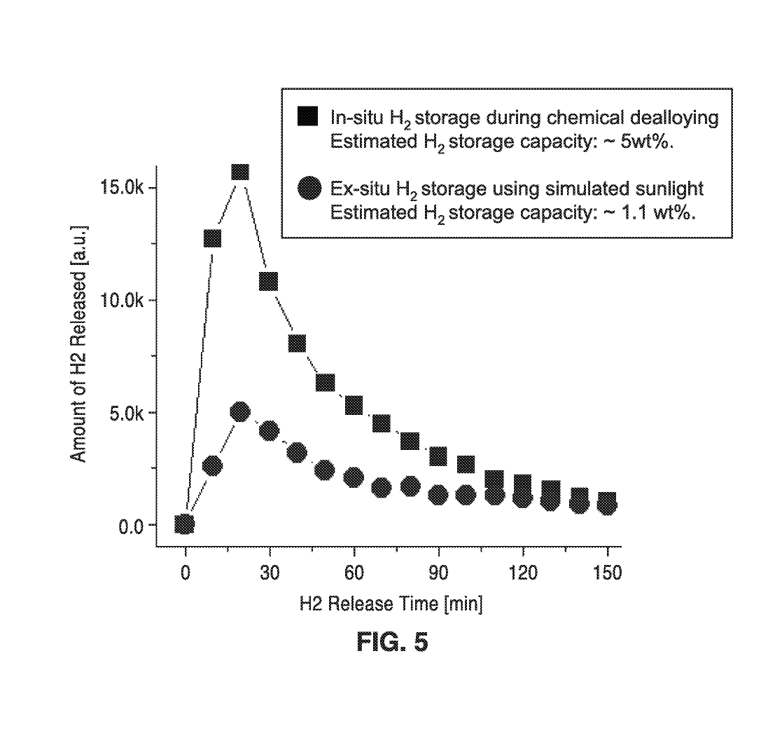

To demonstrate the functionality of the system 38 as a non-chemical synthetic methodology to reversibly and repeatable synthesize NP—AlH₃ for hydrogen storage, nanoporous aluminum (NP—Al) frameworks 40 were synthesized and evaluated. As seen in FIG. 3 and FIG. 5, the system 38 embodiment provides direct storage of H₂ gas in plasmonic nanoporous aluminum using sunlight excitation.

Regeneration of the hydride hydrogen storage capabilities of the nanoporous metal framework also utilized hot electron induced formation but from a different source than dealloying by galvanic corrosion. To charge or recharge the aluminum hydride (AlH₃) on the porous metal NP—Al framework 40, the plasmonic properties of nanostructured metals are exploited to produce hot electrons. In the embodiment shown in FIG. 3, the hot electrons that are used to dissociate hydrogen gas molecules are generated by plasmonic excitation of the nanoporous framework with a light source such as sunlight or a laser.

The onboard hydride (NP—AlH₃) regeneration process began with a NP—Al framework 40 that had pore surfaces that were substantially free of adsorbed gasses or other contaminants. The NP—Al framework 40 was maintained in a H₂ gas atmosphere 44 at ambient temperature and pressure. The molecular hydrogen molecules of the atmosphere 44 were dissociated on the metal surfaces of the pores of the framework 40 by plasmonic excitation from exposure to an artificial sun generated by a solar simulator light source 42 with a broad spectrum.

Since nanoparticles of Al have been shown to exhibit a plasmonic response that is tunable from UV to Near-IR wavelengths depending on the size and shape of the nanoparticles, a variety of NP—Al frameworks 40 with different morphologies were evaluated.

Effective sunlight harvesting using plasmonic nanostructures will require materials that are susceptible to absorbing sunlight ranging from UV to Near-IR wavelengths. One NP—Al framework 40 exhibited a broad plasmonic response ranging from UV to Near-IR wavelengths. The observed plasmonic properties of the NP—Al framework 40 were likely due to the randomness of the shapes of the nanostructures (e.g. ligaments and pores) in the disordered NP—Al.

In contrast, monodisperse Al nanoparticles with a given uniform shape exhibited a narrow plasmonic peak (either in the UV, Visible or Near-IR regime) because the nanoparticles only absorb a relatively narrow fraction of the solar spectrum. Accordingly, these NP—Al frameworks were irradiated with a narrow spectrum light source 42 to dissociate molecular hydrogen onto the NP—Al and form nanoporous aluminum hydride (NP-AlH₃) 46.

The hydrogen gas 48 from the resulting NP—AlH₃ storage material 46 can then be released by mild heating to 100° C. to render and open NP—Al framework 50. The preliminary storage H₂ capacity of the aluminum hydride framework 46 material produced during chemical dealloying and regeneration are shown in FIG. 5. The H₂ storage capacity of the NP—AlH₃ framework 30 generated during chemical dealloying was estimated to be approximately 5 wt %. The estimated ex-situ storage capacity using simulated sunlight was approximately 1.1 wt% and graphs of the two are compared in FIG. 5.

The NP—Al framework 50 can be cycled back through the system and regenerated using plasmon excitation as shown in FIG. 3. Although the regeneration capacity in the preliminary testing was less than produced with chemically dealloying, the regeneration capacity should improve with system and material optimization.

From the description herein, it will be appreciated that that the present disclosure encompasses multiple embodiments which include, but are not limited to, the following:

1. A method for storing hydrogen, the method comprising: (a) forming an alloy of hydride forming metal and an dissimilar chemically active metal; and (b) removing chemically active metal from the alloy in a metal ion electrolyte with galvanic corrosion in a hydrogen atmosphere to produce a nanoporous framework with hydride filled pores; (c) wherein hot electrons produced by galvanic corrosion dissociate hydrogen gas from the hydrogen atmosphere to form metal hydride.

2. The method of any preceding or subsequent embodiment, wherein the hydrogen atmosphere (P_{H2}) has a pressure ranging from 0.05 atm to 10 atm.

3. The method of any preceding or subsequent embodiment, wherein the temperature of the hydrogen atmosphere (P_{H2}) is in the range of between −40° C. and 100° C.

4. The method of any preceding or subsequent embodiment, wherein the hydride forming metal comprises a metal selected from the group of hydride forming metals consisting of Al, Pd, Li, Na, Mg, Ti, Zr, Hf, V, and Zn.

5. The method of any preceding or subsequent embodiment, wherein the hydride forming metal comprises a metal alloy selected from the group of Mg₂FeH₆ or Mg₂NiH₄.

6. The method of any preceding or subsequent embodiment, wherein the hydride forming metal comprises a metal selected from the group of hydride forming metals consisting of the form AₓMHₙ, where A is an alkali or alkaline earth metal and M is a metal.

7. The method of any preceding or subsequent embodiment, wherein the hydride forming metal comprises aluminum and the chemically active metal comprises magnesium with a composition of Al₃₀Mg₇₀ at.%.

8. The method of any preceding or subsequent embodiment, further comprising: heating the nanoporous framework with hydride filled pores to release hydrogen gas to a temperature between 25° C. and 200° C.; and forming nanoporous metal hydride by plasmonic absorption of light by the nanoporous framework in a hydrogen containing atmosphere; wherein hot electrons produced by plasmonic absorption of light by the nanoporous framework dissociates hydrogen gas from the hydrogen atmosphere to form metal hydride.

9. The method of any preceding or subsequent embodiment, wherein the hydrogen atmosphere (P_{H2}) has a pressure ranging from 0.05 atm to 10 atm.

10. The method of any preceding or subsequent embodiment, wherein the temperature of the hydrogen atmosphere (P_{H2}) is in the range of between −40° C. and 100° C.

11. The method of any preceding or subsequent embodiment, wherein the light is selected from the group of visible light, IR light, near IR light, UV light, and any combinations thereof.

12. A hydrogen storage material, comprising: (a) a nanoporous metal framework; and (b) metal hydride on the surfaces of the nanoporous framework.

13. The material of any preceding or subsequent embodiment, wherein the nanoporous metal framework comprises a metal selected from the group of hydride forming metals consisting of Al, Pd, Li, Na, Mg, Ti, Zr, Hf, V, and Zn.

14. The material of any preceding or subsequent embodiment, wherein the nanoporous metal framework comprises a metal selected from the group of Mg₂FeH₆ or Mg₂NiH₄.

15. The material of any preceding or subsequent embodiment, wherein the nanoporous metal framework comprises a metal selected from the group of metals with the form A,MH,, where A is an alkali or alkaline earth metal and M is a metal.

16. A method for reversibly storing and releasing hydrogen, the method comprising: (a) providing a nanoporous framework of at least one hydride forming metal, the framework having a plasmonic resonance; (b) exposing the nanoporous framework to a hydrogen containing atmosphere; and (c) irradiating the nanoporous framework within the hydrogen containing atmosphere with light to form metal hydride by plasmonic absorption of light by the nanoporous framework;(d) wherein hot electrons produced by plasmonic absorption of light by the nanoporous framework dissociates hydrogen gas from the hydrogen containing atmosphere to form metal hydride.

17. The method of any preceding or subsequent embodiment, wherein the hydride forming metal comprises a metal selected from the group of hydride forming metals consisting of Al, Pd, Li, Na, Mg, Ti, Zr, Hf, V, and Zn.

18. The method of any preceding or subsequent embodiment, wherein the hydride forming metal comprises a metal alloy selected from the group of Mg₂FeH₆ or Mg₂NiH₄.

19. The method of any preceding or subsequent embodiment, wherein the hydride forming metal comprises a metal selected from the group of hydride forming metals consisting of the form AₓMHₙ, where A is an alkali or alkaline earth metal and M is a metal.

20. The method of any preceding or subsequent embodiment, wherein the hydrogen atmosphere (P_{H2}) has a pressure ranging from 0.05 atm to 10 atm.

21. The method of any preceding or subsequent embodiment, wherein the temperature of the hydrogen containing atmosphere is in the range of between −40° C. and 100° C.

22. The method of any preceding or subsequent embodiment, wherein the light is selected from the group of visible light, IR light, near IR light, UV light, and any combinations thereof.

23. The method of any preceding or subsequent embodiment, wherein the nanoporous framework is (a) forming an alloy of hydride forming metal and an dissimilar chemically active metal; and (b) removing chemically active metal from the alloy in a metal ion electrolyte with galvanic corrosion in a hydrogen atmosphere to produce a nanoporous framework with hydride filled pores; and (c) heating the nanoporous framework with hydride filled pores to remove the hydride from the hydride filled pores of the nanoporous framework.

24. The method of any preceding or subsequent embodiment, wherein the hydride forming metal comprises aluminum and the chemically active metal comprises magnesium with a composition of Al₃₀Mg₇₀ at.%.

25. The method of any preceding or subsequent embodiment, wherein the nanoporous framework with hydride filled pores is heated to a temperature between 25° C. and 200° C. to release hydrogen gas.

Although the description herein contains many details, these should not be construed as limiting the scope of the disclosure but as merely providing illustrations of some of the presently preferred embodiments. Therefore, it will be appreciated that the scope of the disclosure fully encompasses other embodiments which may become obvious to those skilled in the art.

In the claims, reference to an element in the singular is not intended to mean “one and only one” unless explicitly so stated, but rather “one or more.” All structural, chemical, and functional equivalents to the elements of the disclosed embodiments that are known to those of ordinary skill in the art are expressly incorporated herein by reference and are intended to be encompassed by the present claims. Furthermore, no element, component, or method step in the present disclosure is intended to be dedicated to the public regardless of whether the element, component, or method step is explicitly recited in the claims. No claim element herein is to be construed as a “means plus function” element unless the element is expressly recited using the phrase “means for”. No claim element herein is to be construed as a “step plus function” element unless the element is expressly recited using the phrase “step for”.

What is claimed is:

1. A method for storing hydrogen, the method comprising:
(a) forming an alloy of hydride forming metal and an dissimilar chemically active metal; and
(b) removing chemically active metal from the alloy in a metal ion electrolyte with galvanic corrosion in a hydrogen atmosphere to produce a nanoporous framework with hydride filled pores;
(c) wherein hot electrons produced by galvanic corrosion dissociate hydrogen gas from the hydrogen atmosphere to form metal hydride.

2. The method of claim 1, wherein said hydrogen atmosphere (P_{H2}) has a pressure ranging from 0.05 atm to 10 atm.

3. The method of claim 1, wherein the temperature of said hydrogen atmosphere (P_{H2}) is in the range of between −40° C. and 100° C.

4. The method of claim 1, wherein said hydride forming metal comprises a metal selected from the group of hydride forming metals consisting of Al, Pd, Li, Na, Mg, Ti, Zr, Hf, V, and Zn.

5. The method of claim 1, wherein said hydride forming metal comprises a metal alloy selected from the group of Mg₂FeH₆ or Mg₂NiH₄.

6. The method of claim 1, wherein said hydride forming metal comprises a metal selected from the group of hydride forming metals consisting of the form AₓMHₙ, where A is an alkali or alkaline earth metal and M is a metal.

7. The method of claim 1, wherein said hydride forming metal comprises aluminum and said chemically active metal comprises magnesium with a composition of Al₃₀Mg₇₀ at.%.

8. The method of claim 1, further comprising:
heating the nanoporous framework with hydride filled pores to release hydrogen gas to a temperature between 25° C. and 200° C.; and
forming nanoporous metal hydride by plasmonic absorption of light by the nanoporous framework in a hydrogen containing atmosphere;
wherein hot electrons produced by plasmonic absorption of light by the nanoporous framework dissociates hydrogen gas from the hydrogen atmosphere to form metal hydride.

9. The method of claim 8, wherein said hydrogen atmosphere (P_{H2}) has a pressure ranging from 0.05 atm to 10 atm.

10. The method of claim 8, wherein the temperature of said hydrogen atmosphere (P_{H2}) is in the range of between −40° C. and 100° C.

11. The method of claim 8, wherein said light is selected from the group of visible light, IR light, near IR light, UV light, and any combinations thereof.

12. A hydrogen storage material, comprising:
(a) a nanoporous metal framework; and
(b) metal hydride on the surfaces of said nanoporous framework.

13. The material of claim 12, wherein said nanoporous metal framework comprises a metal selected from the group of hydride forming metals consisting of Al, Pd, Li, Na, Mg, Ti, Zr, Hf, V, and Zn.

14. The material of claim 12, wherein said nanoporous metal framework comprises a metal selected from the group of Mg₂FeH₆ or Mg₂NiH₄.

15. The material of claim 12, wherein said nanoporous metal framework comprises a metal selected from the group of metals with the form AₓMHₙ, where A is an alkali or alkaline earth metal and M is a metal.

16. A method for reversibly storing and releasing hydrogen, the method comprising:
(a) providing a nanoporous framework of at least one hydride forming metal, said framework having a plasmonic resonance;
(b) exposing the nanoporous framework to a hydrogen containing atmosphere; and
(c) irradiating the nanoporous framework within the hydrogen containing atmosphere with light to form metal hydride by plasmonic absorption of light by the nanoporous framework;
(d) wherein hot electrons produced by plasmonic absorption of light by the nanoporous framework dissociates hydrogen gas from the hydrogen containing atmosphere to form metal hydride.

17. The method of claim 16, wherein said hydride forming metal comprises a metal selected from the group of hydride forming metals consisting of Al, Pd, Li, Na, Mg, Ti, Zr, Hf, V, and Zn.

18. The method of claim 16, wherein said hydride forming metal comprises a metal alloy selected from the group of Mg₂FeH₆ or Mg₂NiH₄.

19. The method of claim 16, wherein said hydride forming metal comprises a metal selected from the group of hydride forming metals consisting of the form AₓMHₙ, where A is an alkali or alkaline earth metal and M is a metal.

20. The method of claim 16, wherein said hydrogen atmosphere (P_{H2}) has a pressure ranging from 0.05 atm to 10 atm.

21. The method of claim 16, wherein the temperature of said hydrogen containing atmosphere is in the range of between −40° C. and 100° C.

22. The method of claim 16, wherein said light is selected from the group of visible light, IR light, near IR light, UV light, and any combinations thereof.

23. The method of claim 16, wherein said nanoporous framework is
(a) forming an alloy of hydride forming metal and an dissimilar chemically active metal; and
(b) removing chemically active metal from the alloy in a metal ion electrolyte with galvanic corrosion in a hydrogen atmosphere to produce a nanoporous framework with hydride filled pores; and
(c) heating the nanoporous framework with hydride filled pores to remove the hydride from the hydride filled pores of the nanoporous framework.

24. The method of claim 23, wherein said hydride forming metal comprises aluminum and said chemically active metal comprises magnesium with a composition of Al₃₀Mg₇₀ at.%.

25. The method of claim 23, wherein the nanoporous framework with hydride filled pores is heated to a temperature between 25° C. and 200° C. to release hydrogen gas.
